(19) United States
(12) Patent Application Publication
(10) Pub. No.: US 2008/0199616 A1
(43) Pub. Date: Aug. 21, 2008

(54) METHOD FOR FABRICATING A THREE DIMENSIONAL EMBLEM

(76) Inventor: Ming-Yuan WU, Taipei City (TW)

Correspondence Address: SINORICA, LLC, 528 FALLSGROVE DRIVE, ROCKVILLE, MD, 20850, US

(21) Appl. No.: 12/040,544

(22) Filed: Feb. 29, 2008

Related U.S. Application Data
(63) Continuation-in-part of application No. 11/675,695, filed on Feb. 16, 2007.

(51) Int. Cl. B05D 5/06; B05D 3/12; B05D 1/36; B05D 1/02; B05D 1/28

(52) U.S. Cl. 427/256; 427/402; 427/355; 264/132; 427/421.1; 427/429

(57) ABSTRACT

A method for fabricating a three dimensional emblem is disclosed. A pattern is formed in the back surface of a piece of transparent material. Multiple colors are printed to form an emblem in the pattern. After printing, the pattern is filled with resin to make the back surface of the piece of transparent material flat. When the front surface of the transparent material is viewed, the pattern appears as a three dimensional emblem. Since the emblem is under the front surface of the transparent material, the three dimensional emblem is protected and cannot be inadvertently dislodged from the transparent material.

This application is a continuation-in-part of U.S. patent application Ser. No. 11/675,695, filed Feb. 16, 2007 in the U.S. Patent and Trademark Office, the disclosures of which are incorporated herein by reference.

### BACKGROUND OF THE INVENTION

1. Field of the Invention

The present invention relates to fabricating an emblem. More specifically, the present invention discloses a method for efficiently fabricating an emblem that appears three dimensional but does not protrude from a flat surface.

2. Description of the Prior Art

Emblems are utilized on a wide variety of products to convey a message or identify a brand or product. Conventional emblems are typically glued onto the surface of the product. As such, the emblem is on top of the product's face surface and can easily be dislodged from the product by normal contact. If the emblem falls off the product, the product's appearance is marred thus adversely affecting the consumer's impression of the brand or product.

Another conventional type of emblem is a sticker. The sticker bears a logo or brand name and is adhered to the product. While inexpensive and simple to produce, the sticker's adhesive can easily deteriorate over time and the sticker will come off the product.

Screen-printing is another common way of producing a logo. Text or a brand name is printed onto the face of the product. However, screen-printing in this way limits the logo to a basic two dimensional logo. Additionally, the screen-printed logo is exposed and can easily wear off.

Refer to FIG. 1, which is a drawing illustrating a conventional emblem of the prior art.

An emblem 110 is glued onto the front surface 130 of a mobile telephone 120 with an adhesive. The emblem 110 is raised from the mobile telephone's surface 130 and exposed to the environment. When the mobile telephone 120 is used, stored, or manipulated, the emblem 110 comes in contact with external objects. As a result, the emblem 110 can easily be dislodged from the mobile telephone 120. When this occurs the brand's image is adversely affected.

Typically the conventional logo or emblem is two dimensional. While being functional the conventional logo does not add to the value of the product. In many cases the logo detracts from the appearance of the product.

Therefore, there is need for an improved method of fabricating a three dimensional emblem that allows the emblem to be easily seen but protects the emblem from being inadvertently removed from a product bearing the emblem.

### SUMMARY OF THE INVENTION

To achieve these and other advantages and in order to overcome the disadvantages of the conventional method in accordance with the purpose of the invention as embodied and broadly described herein, the present invention provides a method for fabricating an emblem that appears three dimensional but does not protrude from a flat surface.

The three dimensional emblem produced by the method of the present invention is visually distinctive and enhances the quality of the product bearing the emblem.

The method of the present invention is utilized to produce a three dimensional emblem for a wide variety of products. For example, the three dimensional emblem is produced for a mobile phone, display area of a mobile phone, PDA, portable computer, or other type of product having a transparent portion or part.

In an embodiment of the present invention the method comprises providing a piece of transparent material. The transparent material comprises, for example, polycarbonate (PC), polymethylmethacrylate (PMMA), acrylic, glass, plastic, or other transparent material. An indentation is formed in the back side of the transparent material. Color is then applied to the indentation, for example by screen-printing to produce the emblem. After the coloring process is complete the remaining empty portion of the indentation is filled, for example, with resin, transparent material, or semi-transparent material. After hardening, a second indentation is formed in the top of the filled first indentation. When viewed from the front surface of the transparent material, the emblem appears as a three dimensional emblem.

The emblem does not protrude from the front surface of the transparent material.

In this way, when the front of the transparent material is observed the emblem is easily seen as a three dimensional emblem. An advantage of the present invention is that a three dimensional emblem is produced that doesn't protrude from the front surface of the transparent material.

In another embodiment of the present invention the method for fabricating a three dimensional emblem comprises molding a piece of transparent material. In the molding process an indentation is formed in the back surface of the transparent piece. The indentation is formed in a desired shape for the three dimensional emblem. The emblem is produced by applying color or multiple colors to the indentation. After coloring, a second indention is formed in the colored indentation to produce the three dimensional effect of the emblem.

In another embodiment of the present invention the method comprises printing colors into the indentation after the indentation is formed. Then a colored material, for example a semi-transparent material is inserted into the indentation and adhered to the transparent material's indentation. The colored material has an indentation or indentations in the back surface. These indentations result in the emblem appearing three dimensional.

In another embodiment of the present invention the method comprises molding a transparent material having an indentation in the molded transparent material. After molding, the transparent material is inserted into a second mold and the first indentation is filled with colored material to produce an emblem. During the second molding process a second indentation is formed in the colored material. This second indentation causes the emblem to appear three dimensional when viewed from the front surface of the molded transparent material.

In another embodiment of the present invention the method comprises engraving or etching a pattern or shape into the back side of a piece of transparent material. The engraving is performed, for example, by CNC machining. The pattern is the basis for the three dimensional emblem. The pattern is then colored, for example, by printing. Since the pattern is contoured the emblem will appear three dimensional.

In the method of the present invention in another embodiment the pattern is colored with multiple colors. For example, after the contoured pattern is created in the transparent material a first color is printed into the pattern with portions of the color masked in order to leave portions of the pattern exposed. A second color is then printed into the pattern. The varying contours and depths of the pattern when colored creates a three dimensional effect for the emblem.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a conventional emblem of the prior art;

FIG. 2A is a drawing illustrating a three dimensional emblem according to an embodiment of the present invention;

FIG. 2B is a cross-sectional view of the three dimensional emblem according to an embodiment of the present invention;

FIG. 2C is an enlarged view of the three dimensional emblem illustrated in FIG. 2B;

FIG. 3A is a flowchart illustrating a method for fabricating a three dimension emblem according to an embodiment of the present invention;

FIG. 3B is a drawing illustrating a three dimensional emblem according to an embodiment of the present invention;

FIG. 4 is a flowchart illustrating a method for fabricating a three dimension emblem according to an embodiment of the present invention;

FIG. 5 is a flowchart illustrating a method for fabricating a three dimension emblem according to an embodiment of the present invention;

FIG. 6A is a flowchart illustrating a method for fabricating a three dimension emblem according to an embodiment of the present invention;

FIG. 6B is a cross-sectional view illustrating a pattern and printing for a three dimensional emblem according to an embodiment of the present invention;

FIG. 7A is a flowchart illustrating a method for fabricating a three dimension emblem according to an embodiment of the present invention;

FIG. 7B is a cross-sectional view of a three dimensional emblem according to an embodiment of the present invention;

FIG. 8A is a side view of a lens with a three dimensional emblem according to an embodiment of the present invention;

FIG. 8B is a front view of a lens with a three dimensional emblem according to an embodiment of the present invention;

FIG. 9A is a side view of a lens with a three dimensional emblem according to an embodiment of the present invention;

FIG. 9B is a front view of a lens with a three dimensional emblem according to an embodiment of the present invention;

FIG. 10A is a side view of a lens with a three dimensional emblem according to an embodiment of the present invention;

FIG. 10B is a front view of a lens with a three dimensional emblem according to an embodiment of the present invention;

FIG. 11A is a side view of a lens with a three dimensional emblem according to an embodiment of the present invention;

FIG. 11B is a front view of a lens with a three dimensional emblem according to an embodiment of the present invention;

FIG. 12A is a side view of a lens with a three dimensional emblem according to an embodiment of the present invention;

FIG. 12B is a front view of a lens with a three dimensional emblem according to an embodiment of the present invention;

FIG. 13A is a side view of a lens with a three dimensional emblem according to an embodiment of the present invention;

FIG. 13B is a front view of a lens with a three dimensional emblem according to an embodiment of the present invention;

FIG. 14A is a side view of a lens with a three dimensional emblem according to an embodiment of the present invention; and

FIG. 14B is a front view of a lens with a three dimensional emblem according to an embodiment of the present invention.

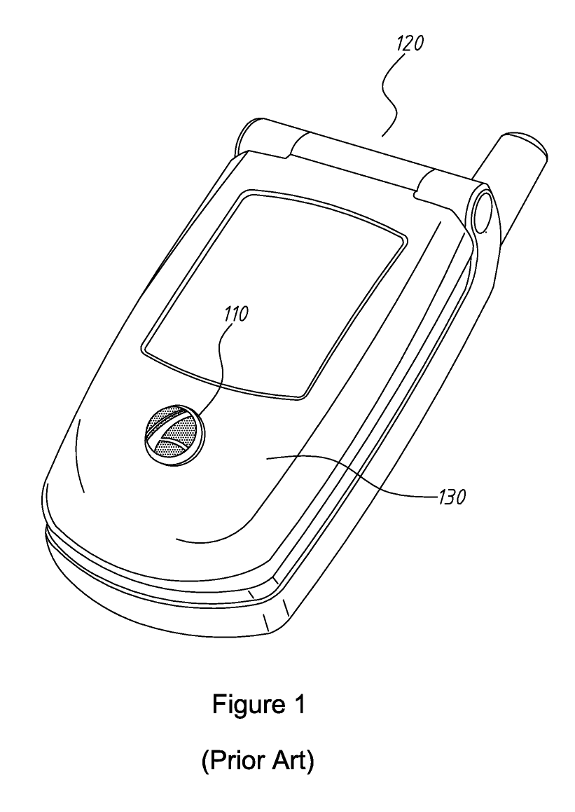

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

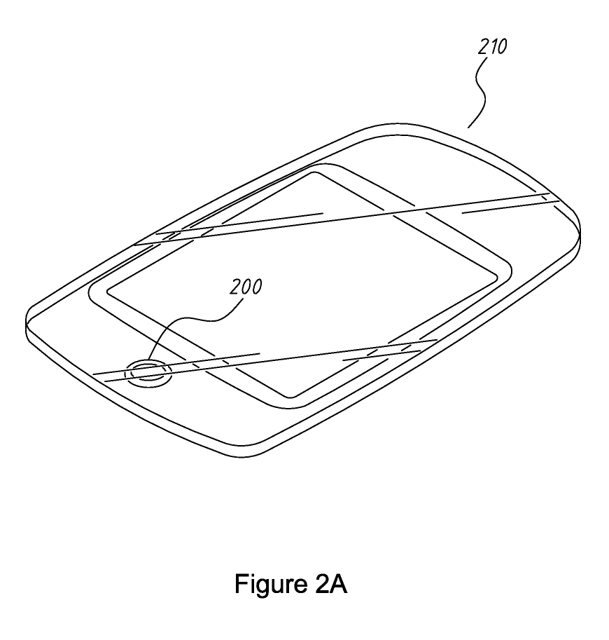

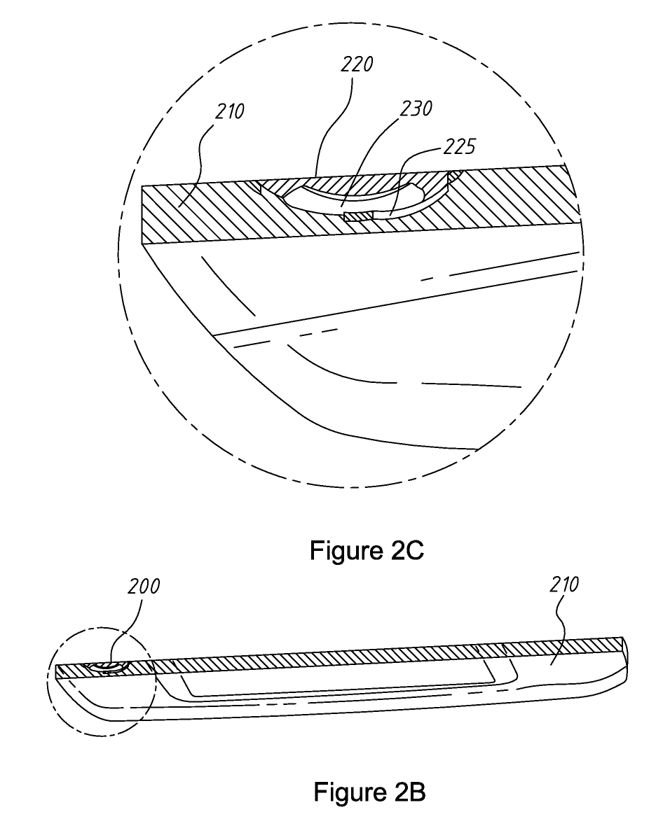

Refer to FIG. 2A, which is a drawing illustrating a three dimensional emblem according to an embodiment of the present invention, to FIG. 2B, which is a cross-sectional view of the three dimensional emblem according to an embodiment of the present invention, and to FIG. 2C, which is an enlarged view of the three dimensional emblem illustrated in FIG. 2B.

In the embodiment illustrated in FIGS. 2A, 2B, and 2C, the method of the present invention is utilized to produce a three dimensional emblem 200 in the display cover 210 of a mobile phone. However, the present invention can be used to produce a three dimensional emblem in a wide variety of products.

An indentation is formed in the back surface of the display cover 210. A first color 225 is printed into portions of the indentation. The indentation is masked so that portions of the first color 225 are printed into the indentation and portions of the indentation are not printed on by the first color 225. Next, the exposed portions of the indentation are printed by a second color 230. Finally, the remaining empty portion of the indentation is filled with, for example, resin 220 to make the back side of the display cover 210 substantially flat and smooth. As a result, when the front side of the display cover 210 is observed the three dimensional emblem 200 is easily seen and creates a three dimensional effect as an emblem.

In an embodiment of the present invention the method further comprises forming a second indentation in the filled indentation to further enhance the emblem's three dimensional effect.

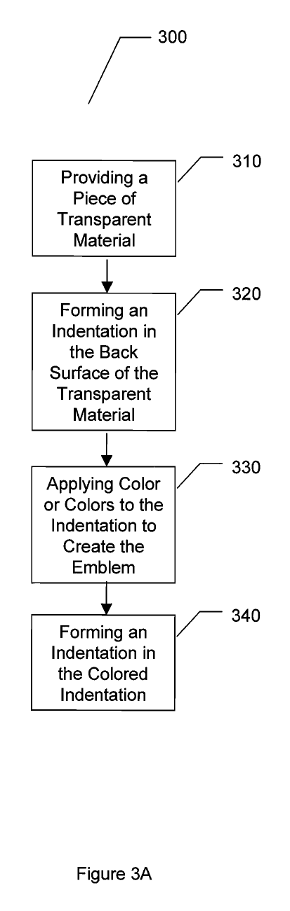

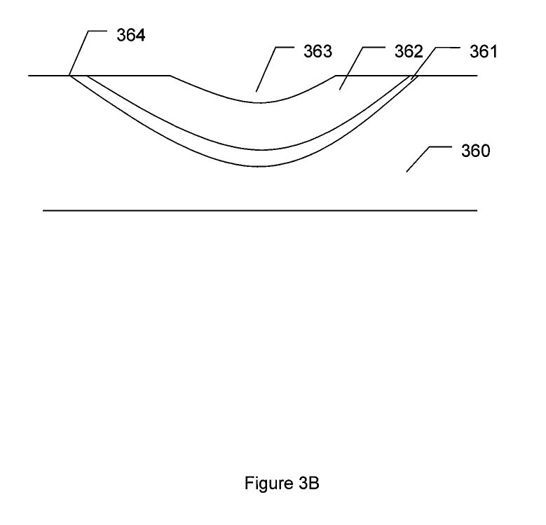

Refer to FIG. 3A, which is a flowchart illustrating a method for fabricating a three dimension emblem according to an embodiment of the present invention.

In the embodiment of the present invention illustrated in FIG. 3A the method 300 comprises providing a piece of transparent material in Step 310. The transparent material comprises, for example, polycarbonate (PC), polymethylmethacrylate (PMMA), acrylic, glass, plastic, or other transparent material. An indentation is formed in the back side of the transparent material in Step 320. The indentation is formed by, for example, drilling, etching, or CNC machining. The shape of the indentation is, for example, a round concaved shape. In Step 330 color or colors are applied to the indentation to create the emblem. The colors comprise, for example, screen-printing colors or colored resin. Finally in Step 340, an indentation is formed in the colored indentation to cause the emblem to appear three dimensional when viewed.

In this way, when the front of the transparent material is observed the emblem is easily seen as a three dimensional emblem. An advantage of the present invention is that a three dimensional emblem is produced that doesn't protrude from the front surface of the transparent material.

Refer to FIG. 3B, which is a drawing illustrating a three dimensional emblem according to an embodiment of the present invention.

As shown in FIG. 3B, a first indentation 364 is formed in a piece of transparent material 360. A first color 361 and a second color 362 are applied to the first indentation 364. A second indentation 363 is formed in the colored indentation to form the three dimensional emblem.

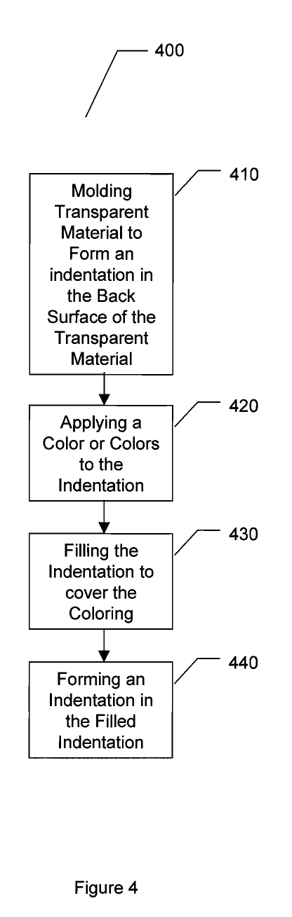

Refer to FIG. 4, which is a flowchart illustrating a method for fabricating a three dimension emblem according to an embodiment of the present invention.

In the embodiment of the present invention illustrated in FIG. 4 the method 400 for fabricating a three dimensional emblem comprises molding a piece of transparent material in Step 410. In the molding process an indentation is formed in the back surface of the transparent piece. The emblem is created in the indentation in Step 420 by applying color or colors to the indentation. The colored indentation is then filled in order to make the back surface of the transparent piece flat or smooth in Step 430. An indentation is formed in the filled indentation in Step 440. This second indentation is smaller than the first indentation. In an embodiment of the present invention the first indentation is a round concaved shape and the second indentation is a round concaved shape of 10% to 90% in size relative to the size of the first indentation.

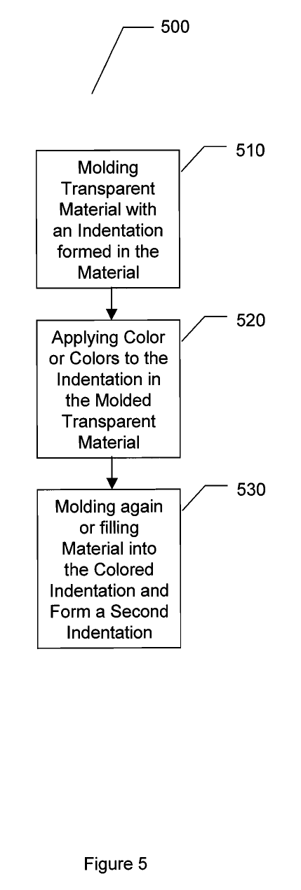

Refer to FIG. 5, which is a flowchart illustrating a method for fabricating a three dimension emblem according to an embodiment of the present invention.

In the embodiment of the present invention illustrated in FIG. 5 the method 500 for fabricating a three dimensional emblem comprises molding a piece of transparent material where an indentation is formed in the transparent material during the molding process in Step 510. Color is applied to portions of the indentation in the transparent material in Step 520. The transparent material is then inserted into a second mold and the indentation is filled with a colored material in Step 530. The colored material is, for example, a colored resin or semi-transparent colored resin. During the second molding process an indentation is formed in the colored material. The three dimensional emblem is visible from the front of the transparent material but doesn't extend above the surface of the transparent material.

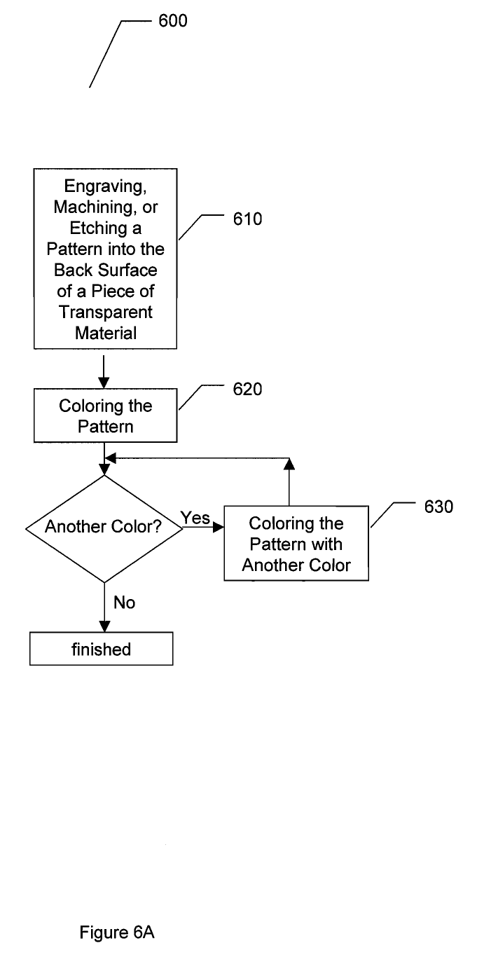

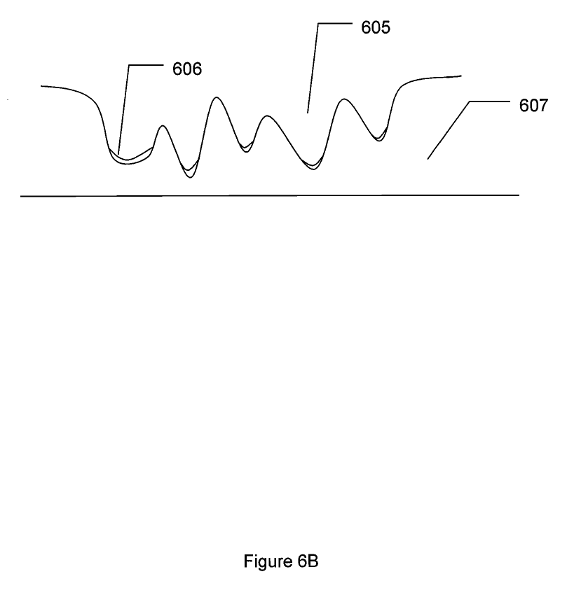

Refer to FIG. 6A, which is a flowchart illustrating a method for fabricating a three dimension emblem according to an embodiment of the present invention and to FIG. 6B, which is a cross-sectional view illustrating a pattern and printing for a three dimensional emblem according to an embodiment of the present invention.

In the embodiment of the present invention illustrated in FIG. 6 the method 600 comprises engraving, machining, or etching a pattern or shape into the back side of a piece of transparent material in Step 610. The pattern is the basis for the three dimensional emblem. The pattern is then colored, for example, by printing 620. Since the pattern is contoured and has varying depth, the emblem will appear three dimensional.

In the method 600 of the present invention in another embodiment the pattern is colored with multiple colors. For example, after the contoured pattern is created in the transparent material in Step 610 a first color is printed into the pattern with portions of the color masked in order to leave portions of the pattern exposed in Step 620. A second color is then printed into the pattern Step 630.

As shown in FIG. 6B, the pattern 605 is contoured and extends to various depths. In this way, after the pattern 605 is colored by the printing 606 the pattern will have a three dimensional effect when viewed from the front of the transparent material 607.

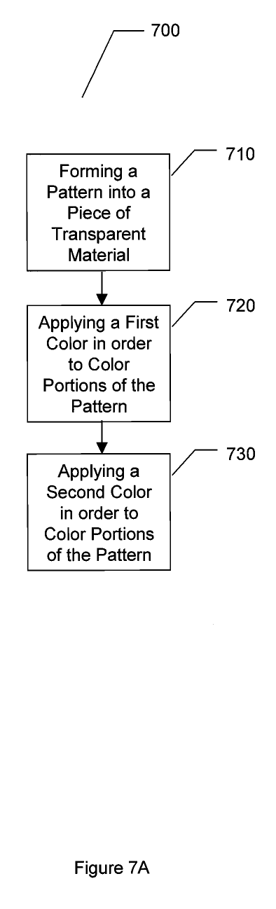

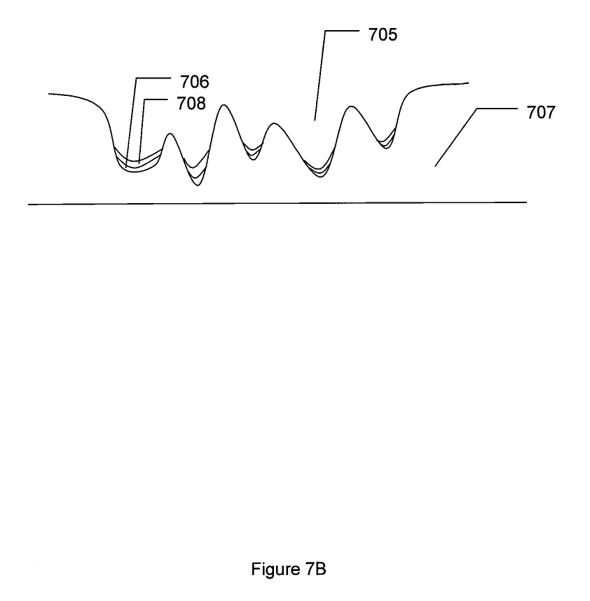

Refer to FIG. 7A, which is a flowchart illustrating a method for fabricating a three dimension emblem according to an embodiment of the present invention and to FIG. 7B, which is a cross-sectional view of a three dimensional emblem according to an embodiment of the present invention.

In the embodiment of the present invention illustrated in FIG. 7A the method 700 comprises forming a pattern in a piece of transparent material in Step 710. A first color is printed into the pattern in Step 720. The first color only covers a portion of the pattern. A second color is then printed into the pattern in Step 730.

As shown in FIG. 7B, the pattern 705 has varying depths and contours. The first color 706 and the second color 708 cover various portions of the pattern 705 and are visible from the front of the transparent material 707 at various areas.

In another embodiment of the present invention the method for fabricating a three dimensional emblem comprises molding transparent material so that a pattern is formed in the molded material. The pattern comprises, for example, a logo, a shape, text, or abstract art. Color or colors are added to the pattern, for example, by spray paint, tape, or coating. Since the walls of the pattern and the depth of the pattern's indentation vary, a three dimensional effect is created. This method provides a low cost means of producing a high quality three dimensional emblem easily by creating a pattern for the emblem while molding the transparent material. Then the pattern is simply printed to add color for the emblem. When viewed from the front side of the transparent material, the effective three dimensional emblem is seen.

In another embodiment of the present invention the method comprises applying color to an indentation or pattern in a transparent or semi-transparent material. Then a colored material, for example a semi-transparent material is inserted into the indentation and adhered to the transparent material's indentation. The colored material has an indentation or indentations in the back surface. These indentations result in the emblem appearing three dimensional. In an embodiment of the present invention after an indentation is formed in the transparent material and indentation is printed, the indentation is filled to make the surface of the transparent material substantially flat. In another embodiment of the present invention the indentation is not filled after color is applied. In another embodiment of the present invention after the indentation has been printed and filled, a second indentation is formed in the filled first indentation. This second indentation further increases the three dimensional effect of the emblem.

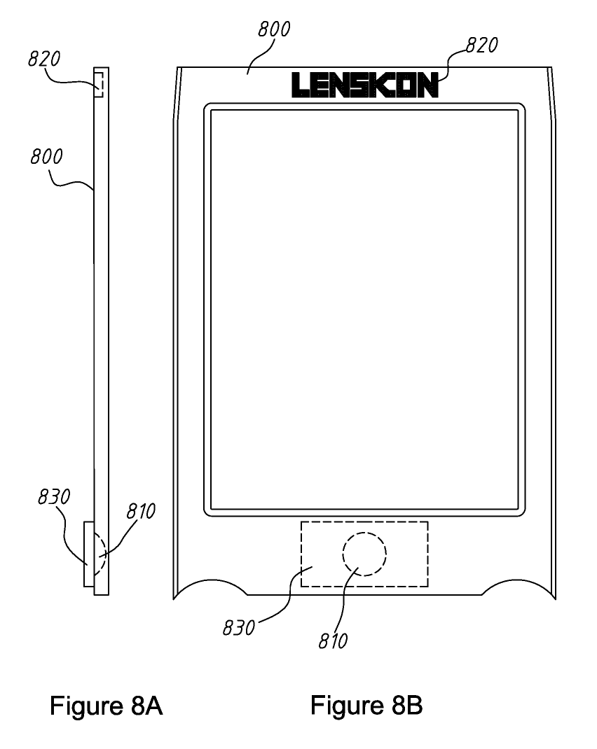

Refer to FIG. 8A, which is a side view of a lens with a three dimensional emblem according to an embodiment of the present invention and to FIG. 8B, which is a front view of a lens with a three dimensional emblem according to an embodiment of the present invention.

In the embodiment illustrated in FIGS. 8A and 8B an indentation 810 is formed, for example by molding or machining, in the back surface of an object 800. In this example the object 800 is a plastic lens for a cellular telephone. However, in other embodiments other objects are utilized. A logo 820 is also formed in the back surface of the lens 800. Printing or color is applied to the logo 820 for visibility. A sticker 830, for example a laser sticker, is applied to the lens 800 and covers the indentation 810. When an observer views the front side of the lens 800 the sticker 830 and the logo 820 will have a 3D effect from different angles.

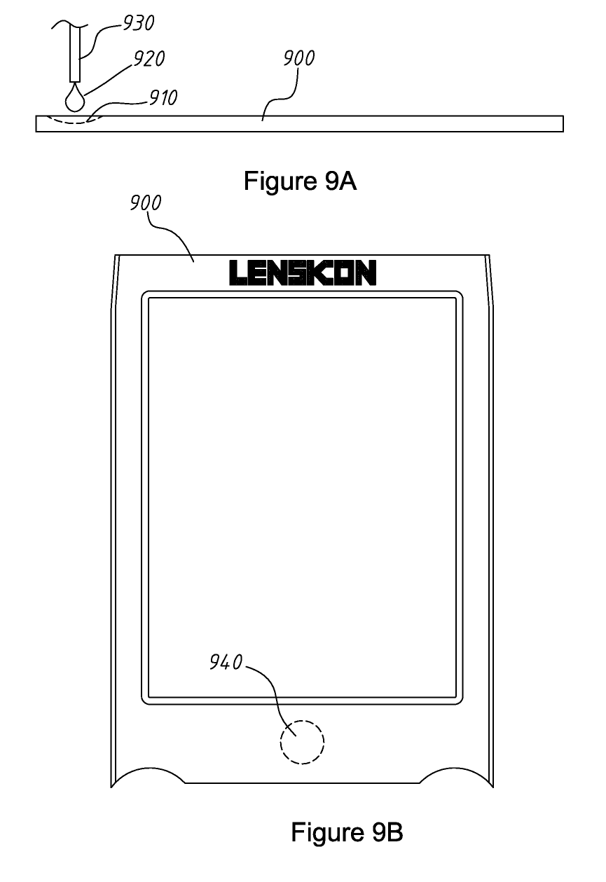

Refer to FIG. 9A, which is a side view of a lens with a three dimensional emblem according to an embodiment of the present invention and to FIG. 9B, which is a front view of a lens with a three dimensional emblem according to an embodiment of the present invention.

As shown in FIGS. 9A and 9B an indentation 910 is formed in the back surface of the lens 900. A semitransparent or opaque material 920, for example paint, ink, or glue, is applied to the indentation 910 via a dropper needle 930 or nozzle. In an embodiment of the present invention the dropper needle 930 is hollow. In another embodiment of the present invention the dropper needle 930 is solid. The material 920 is dropped onto portions of the lens 900 and then cured to harden. The hardened material can then be machined as required. When the lens 900 is viewed from the front the created colored emblem 940 will appear three dimensional. Light shining through the emblem will have different intensities due to varying thickness of the colored material, thickness of the lens, and depth of the indentation.

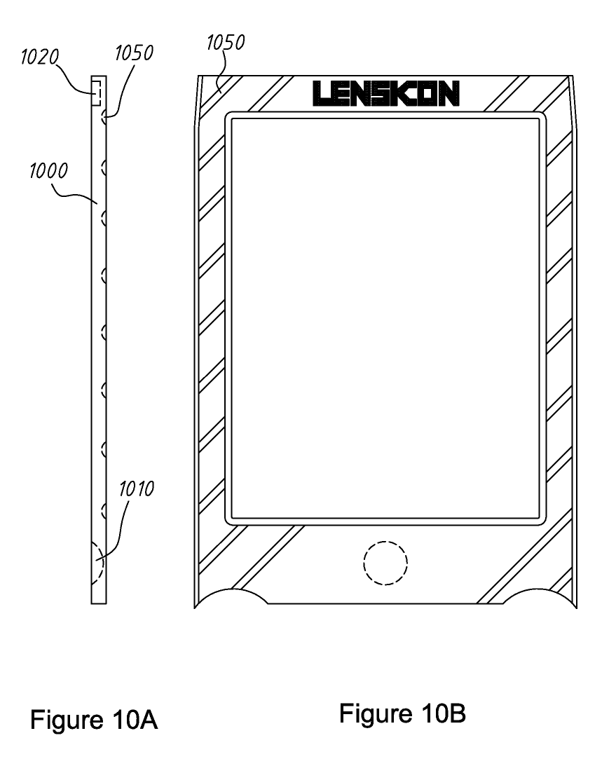

Refer to FIG. 10A, which is a side view of a lens with a three dimensional emblem according to an embodiment of the present invention and to FIG. 10B, which is a front view of a lens with a three dimensional emblem according to an embodiment of the present invention.

In this embodiment the indention 1010 is colored as in FIGS. 9A and 9B or covered as in FIGS. 8A and 8B. In addition a pattern 1050 is formed in the front surface of the lens 1000. In this embodiment the pattern 1050 is a series of concave lines. However, in other embodiments the pattern 1050 comprises more complex designs. In an embodiment of the present invention a semitransparent colored material is then applied to the pattern 1050. In another embodiment the pattern 1050 is not colored.

When the lens 1000 is viewed from the front the pattern 1050 on the front surface of the lens 1000 will appear three dimensional. Light shining through the pattern will have different intensities due to varying thickness of the colored material, thickness of the lens, and depth of the pattern.

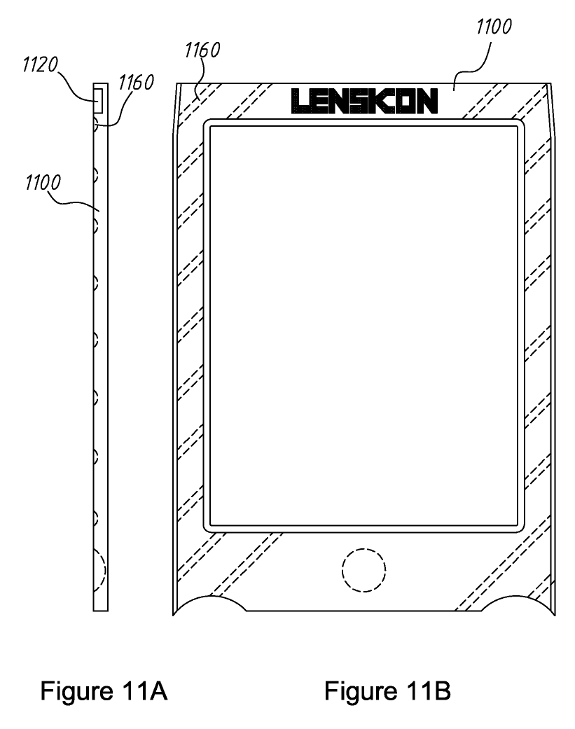

Refer to FIG. 11A, which is a side view of a lens with a three dimensional emblem according to an embodiment of the present invention and to FIG. 11B, which is a front view of a lens with a three dimensional emblem according to an embodiment of the present invention.

The embodiment illustrated in FIGS. 11A and 11B is similar to the embodiment illustrated in FIGS. 10A and 10B. However, in this embodiment the pattern 1160 is formed in the back surface of the lens 1100. A semitransparent colored material is then applied to the pattern 1160.

When the lens 1100 is viewed from the front the pattern 1160 on the back surface of the lens 1100 will appear three dimensional. Light shining through the pattern will have different intensities due to varying thickness of the colored material, thickness of the lens, and depth of the pattern.

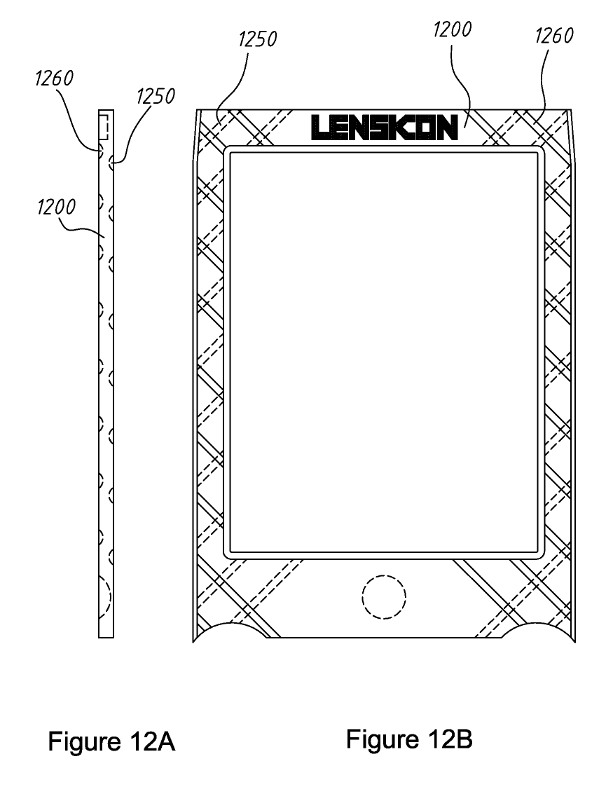

Refer to FIG. 12A, which is a side view of a lens with a three dimensional emblem according to an embodiment of the present invention and to FIG. 12B, which is a front view of a lens with a three dimensional emblem according to an embodiment of the present invention.

In the embodiment illustrated in FIGS. 12A and 12B a front pattern 1250 is formed on the front surface of the lens 1200 and a back pattern 1260 is formed on the back surface of the lens 1200. A semitransparent colored material is then applied to the back pattern 1260. The uncolored front pattern 1250 enhances the 3 dimensional effect by varying the thickness of the transparent material of the lens between the colored back pattern 1260 and the front surface of the lens.

When the lens 1200 is viewed the front pattern 1250 on the front surface of the lens and the back pattern 1260 on the back surface of the lens will both appear three dimensional. Light shining through the patterns will have different intensities due to varying thickness of the colored materials, thickness of the lens, depth of the patterns, relationships between the two patterns, and overlapping of the two patterns.

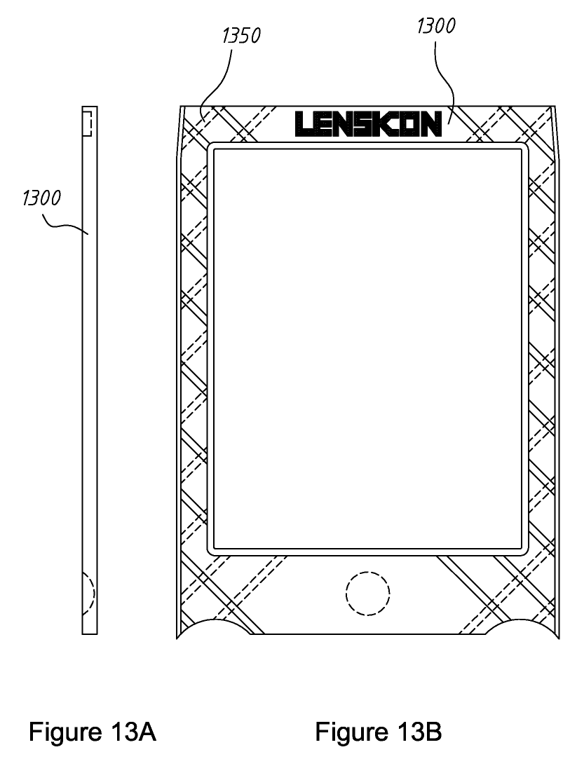

Refer to FIG. 13A, which is a side view of a lens with a three dimensional emblem according to an embodiment of the present invention and to FIG. 13B, which is a front view of a lens with a three dimensional emblem according to an embodiment of the present invention.

In the embodiment illustrated in FIGS. 13A and 13B a plurality of patterns 1350,1360 are printed on the lens 1300. The patterns 1350,1360 are printed on one side of the lens 1300 or both sides of the lens 1300.

The patterns will appear three dimensional due to relationships between the patterns.

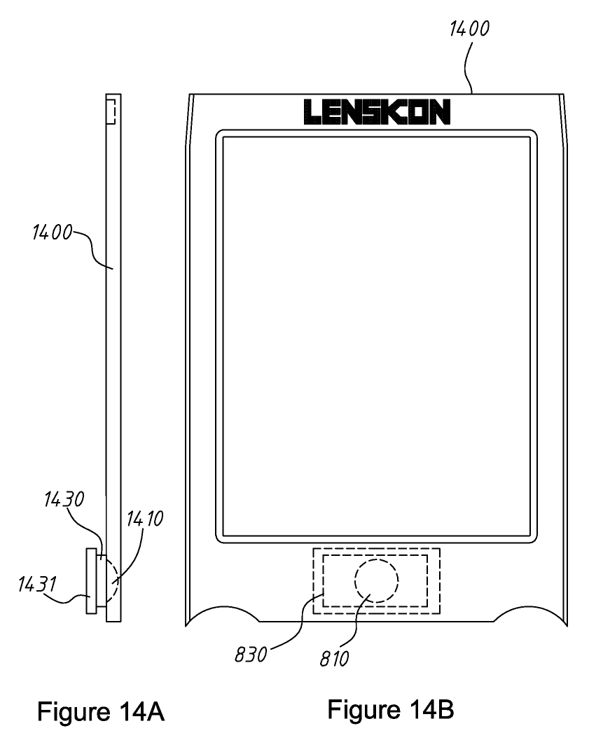

Refer to FIG. 14A, which is a side view of a lens with a three dimensional emblem according to an embodiment of the present invention and to FIG. 14B, which is a front view of a lens with a three dimensional emblem according to an embodiment of the present invention.

The embodiment illustrated in FIGS. 14A and 14B are similar to the embodiment illustrated in FIGS. 8A and 8B. However, in this embodiment a plurality of stickers or films 1430,1431 are placed over the indentation 1410 in the back surface of the lens 1400. In an embodiment of the present invention element 1430 is film and element 1431 is tape.

When an observer views the front side of the lens 1400 the emblem 1440 will have a 3D effect from different angles.

In embodiments of the present invention the three dimensional emblem comprises logos, patterns, shapes, designs, text, or other graphical elements.

In an embodiment of the present invention an object is inserted into the concave pattern created in the surface of the transparent material. The inserted object is then attached by tape. For example, an object is inserted in a concave pattern in the back surface of the transparent material and a portion of tape is placed over the object thereby affixing the object to the transparent material.

As described, the method for fabricating a three dimensional emblem of the present invention provides an effective and efficient way of producing an emblem in a transparent material that creates a three dimensional effect. The method also produces a three dimensional emblem that does not protrude or extend above the surface thereby preventing inadvertent dislodging of the emblem.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for fabricating an emblem comprising:
providing a piece of transparent material;
forming a pattern in a surface of the transparent material;
applying at least one color to the pattern; and
filling the pattern so that the surface of the transparent material is flat.

2. The method for fabricating an emblem of claim 1, the transparent material comprising polycarbonate (PC), polymethylmethacrylate (PMMA), acrylic, glass, or plastic.

3. The method for fabricating an emblem of claim 1, further comprising:
polishing the surface of the transparent material after the pattern is formed.

4. The method for fabricating an emblem of claim 1, further comprising forming a second pattern in the pattern after the pattern is filled.

5. The method for fabricating an emblem of claim 1, wherein the pattern is filled with resin.

6. The method for fabricating an emblem of claim 1, wherein the pattern is formed by machining.

7. A method for fabricating an emblem comprising:
molding transparent material with a pattern formed in a surface of the transparent material;
applying color to the pattern; and
filling the pattern.

8. The method for fabricating an emblem of claim 7, the transparent material comprising polycarbonate (PC), polymethylmethacrylate (PMMA), acrylic, glass, or plastic.

9. The method for fabricating an emblem of claim 7, further comprising forming a second pattern in the pattern after the pattern is filled.

10. The method for fabricating an emblem of claim 7, wherein the pattern is filled with resin.

11. A method for fabricating an emblem comprising:
forming a first pattern in a front surface of a transparent material;
forming a second pattern in a back surface of the transparent material; and
applying color to the first pattern and the second pattern.

12. The method for fabricating an emblem of claim 11, the transparent material comprising polycarbonate (PC), polymethylmethacrylate (PMMA), acrylic, glass, or plastic.

13. A method for fabricating a three dimensional emblem comprising:
forming a pattern having multiple depths and contours into a surface of a piece of transparent material;
coloring the pattern with at least one color to produce the three dimensional emblem.

14. The method for fabricating a three dimensional emblem of claim 13, the transparent material comprising polycarbonate (PC), polymethylmethacrylate (PMMA), acrylic, glass, or plastic.

15. The method for fabricating a three dimensional emblem of claim 13, wherein the pattern is colored by painting, spray painting, film, tape, or coating.

16. A method for fabricating an emblem comprising:
forming a pattern having multiple depths and contours into a surface of a piece of transparent material;
coloring the pattern with a first color leaving portions of the pattern exposed;
coloring the exposed portions of the pattern with a second material; and
filling the pattern to make the surface of the transparent material flat.

17. The method for fabricating an emblem of claim 16, the transparent material comprising polycarbonate (PC), polymethylmethacrylate (PMMA), acrylic, glass, or plastic.

18. A method for fabricating an emblem comprising:
forming a first pattern into a surface of a transparent material;
coloring the first pattern with at least one color;
forming a second pattern into an opposite surface of the transparent material; and
coloring the second pattern with at least one color.

19. The method for fabricating an emblem of claim 18, the transparent material comprising polycarbonate (PC), polymethylmethacrylate (PMMA), acrylic, glass, or plastic.

20. The method for fabricating an emblem of claim 18, further comprising:
filling the first pattern with curable material after coloring.
